(19) United States
(12) Patent Application Publication
(10) Pub. No.: US 2013/0015278 A1
(43) Pub. Date: Jan. 17, 2013

(54) Tobacco Grinder

(71) Applicant: Mark E. Edwards, Los Gatos, CA (US)

(72) Inventor: Mark E. Edwards, Los Gatos, CA (US)

(21) Appl. No.: 13/433,060

(22) Filed: Jun. 11, 2012

Related U.S. Application Data
(60) Provisional application No. 61/465,922, filed on Mar. 28, 2011.

(51) Int. Cl. A47J 42/40

(52) U.S. Cl. 241/69

(57) ABSTRACT

The Santa Cruz Shredder incorporates a custom radial angular cutting tooth design. With this design the cutting and grinding of herbs creates a very fine grind. This tooth design allows for bidirectional cutting and grinding. The placement of the multiple cutting teeth on the Santa Cruz Shredder grinders has been strategically positioned for maximum grind efficiency.

The Santa Cruz Shredder incorporates a custom radial angular cutting tooth design (See FIG. 1). With this design the cutting and grinding of herbs creates a very fine grind. This tooth design allows for bidirectional cutting and grinding. The multiple cutting teeth placement on the Santa Cruz Shredder grinders have been strategically positioned for maximum grind efficiency.

### PRODUCTION PROCEDURE

Step 1—Obtain Round 60-61 Aluminum Bar Stock.

Step 2—Cut into 4 foot bars.

Step 3—Place bar stock on bar loader of CNC Turning Centre.

Step 4—Lathe process on all pieces

Step 5—Parts that require teeth are sent to Milling Centre to have the teeth cut.

Step 6—The aluminum pieces are polished, cleansed, disinfected in preparation for anodizing.

Step 7—Magnets and screens are pressed in.

Step 8—Laser engraved

Step 9—Assemble the components for finished product

### FIGURE DESCRIPTIONS

FIG. 1A—Large and medium size tooth profile

FIG. 1B—Small size tooth profile

FIG. 2—Small 2 Part Assembly Sheet

FIG. 3—Medium 2 Part Assembly Sheet

FIG. 4—Large 2 Part Assembly Sheet

FIG. 5—Small 4 Part Assembly Sheet

FIG. 6—Medium 4 Part Assembly Sheet

FIG. 7—Large 4 Part Assembly Sheet

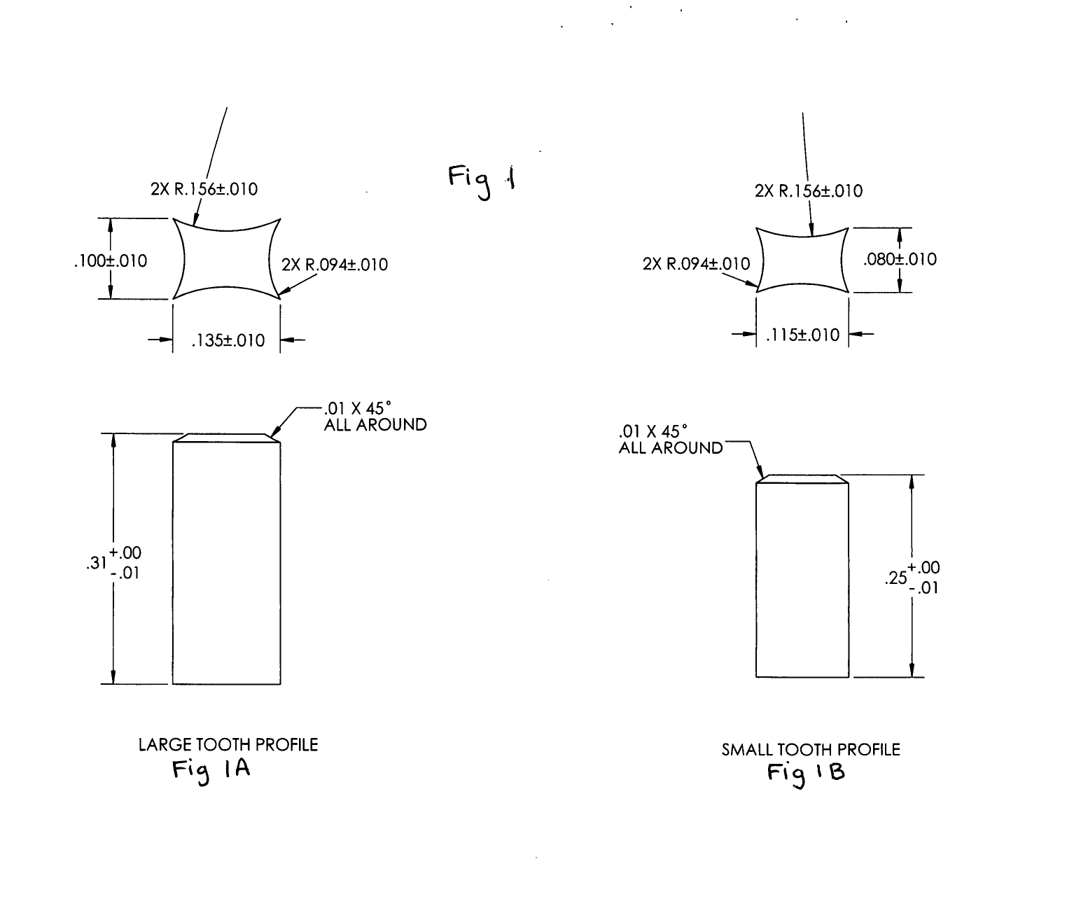

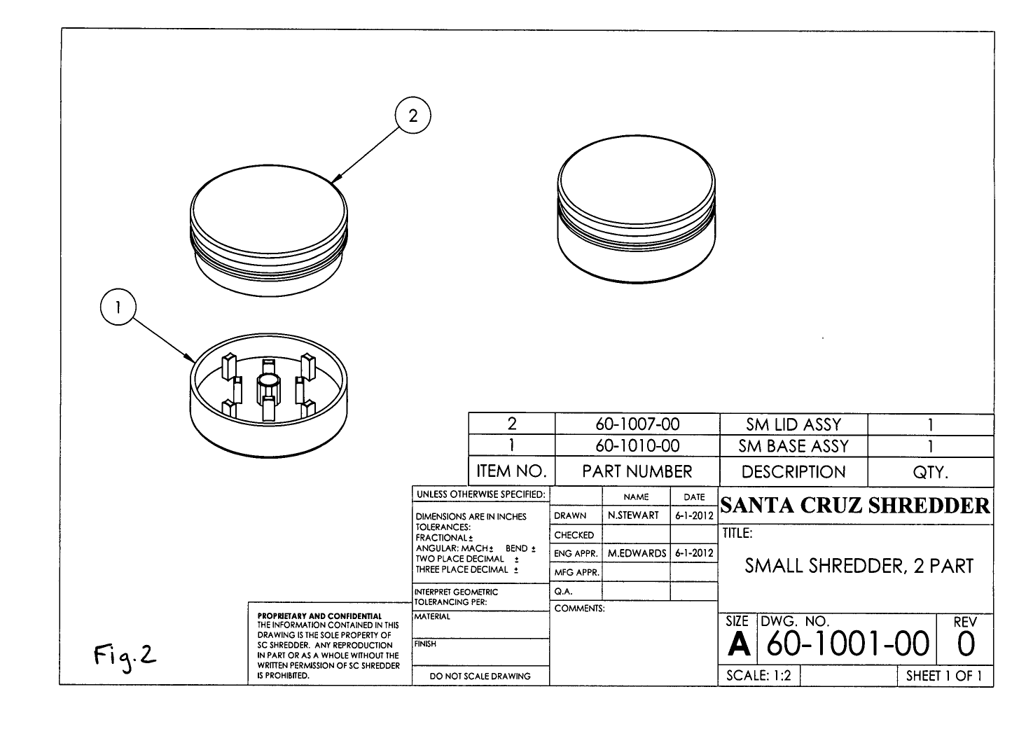

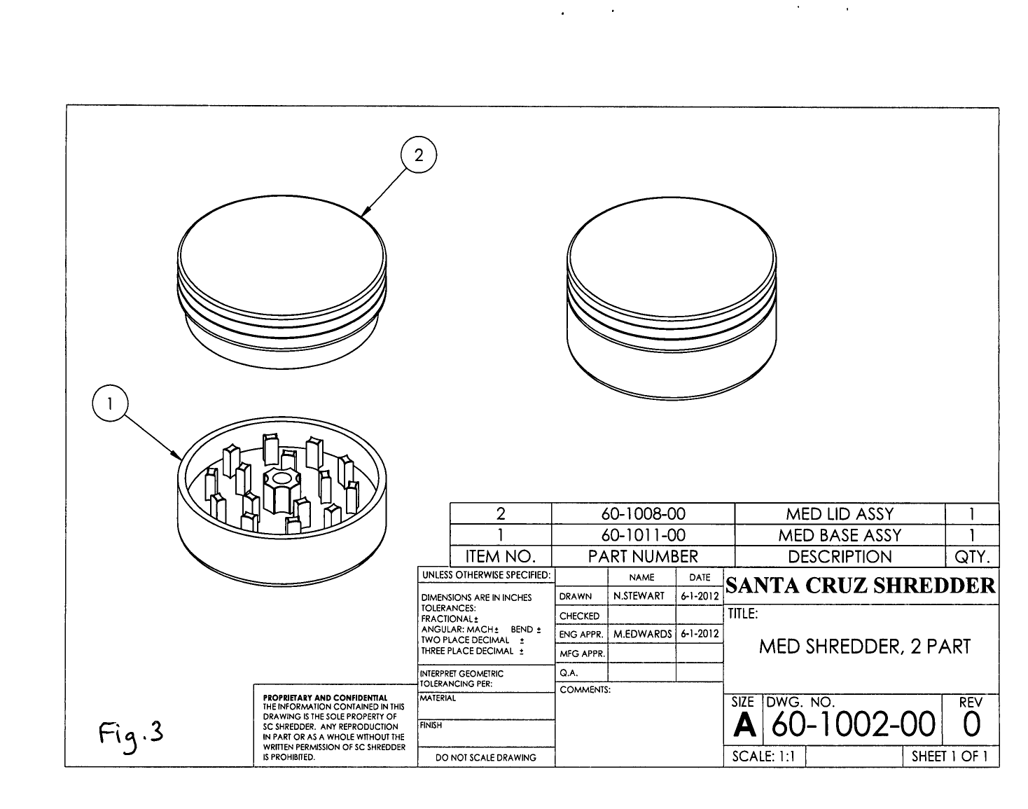

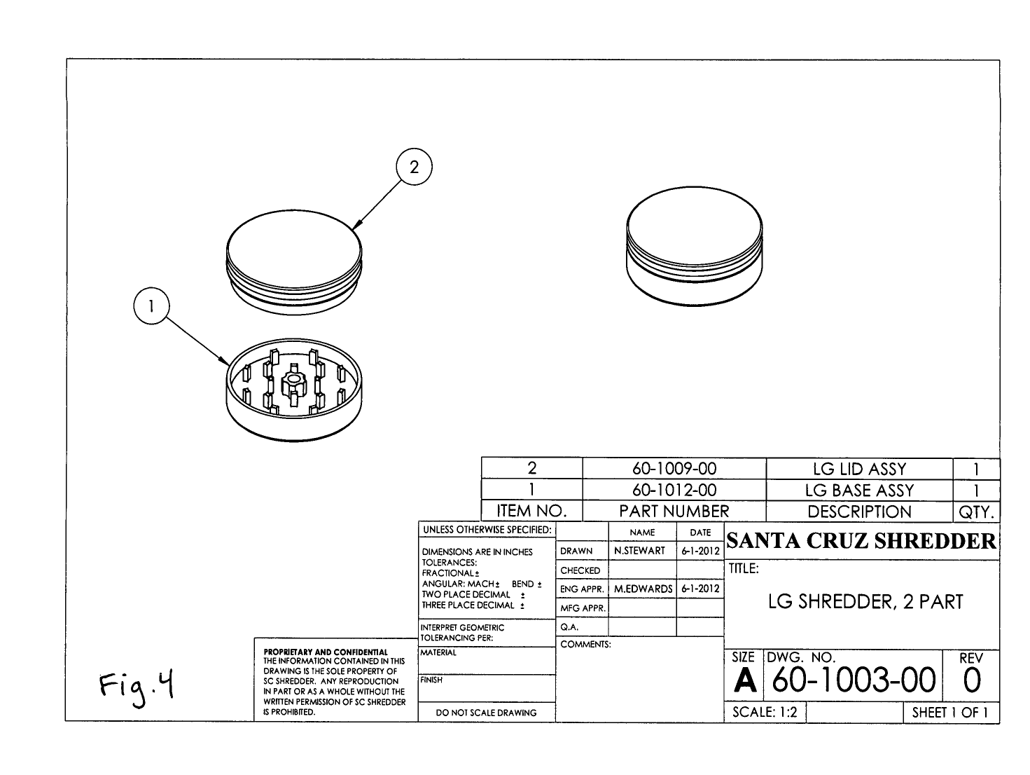

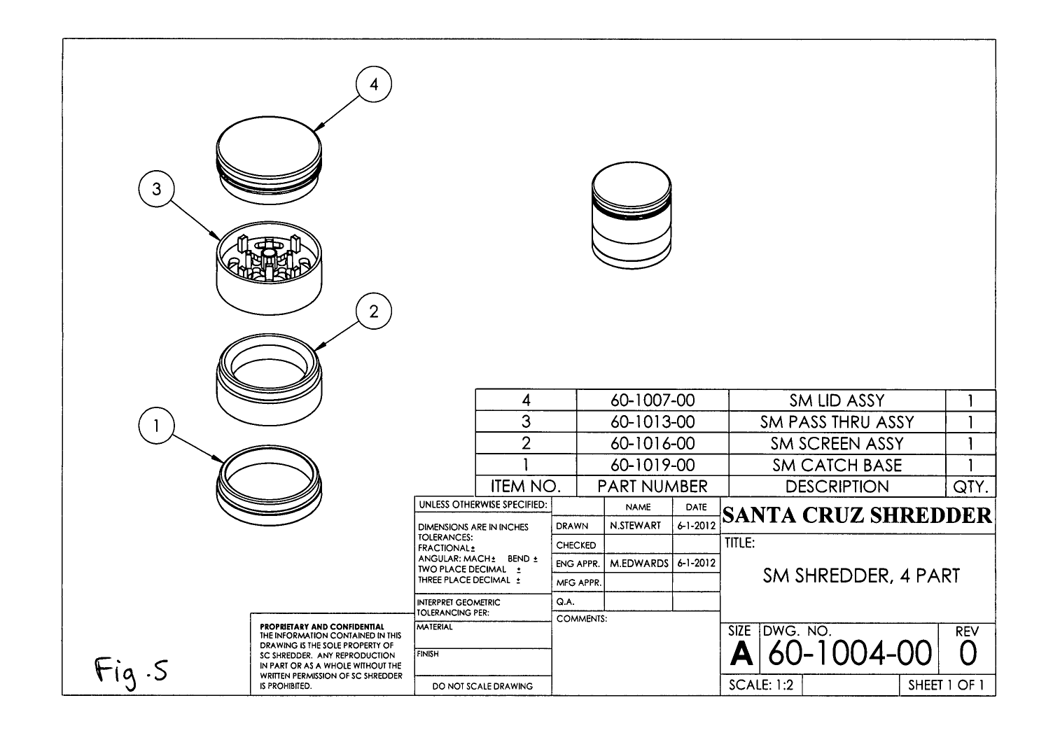

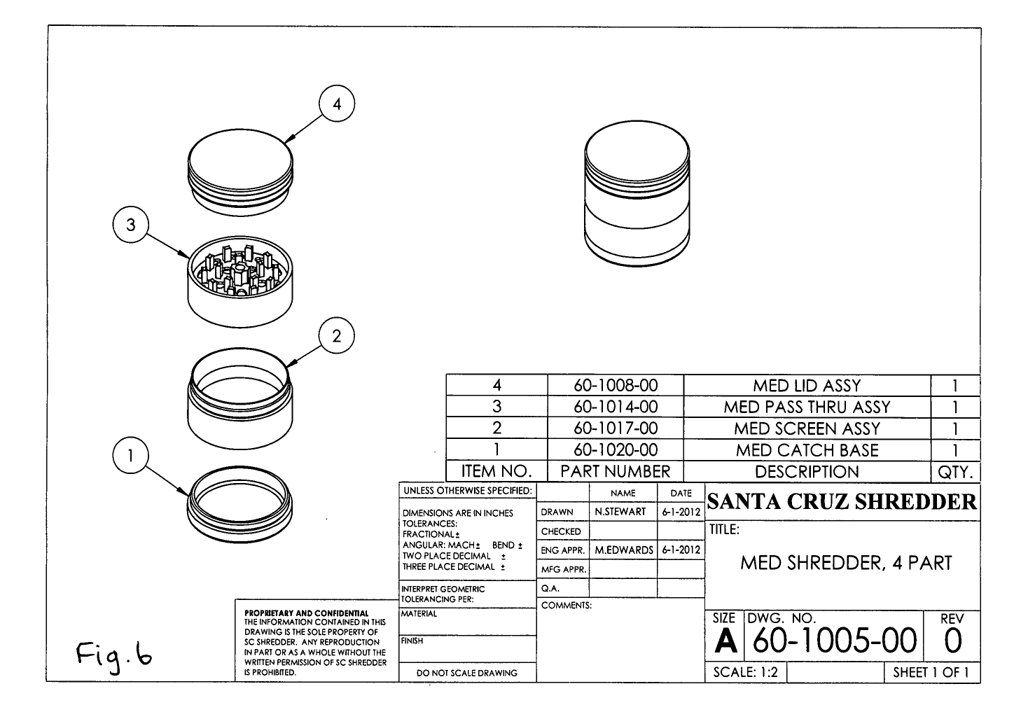

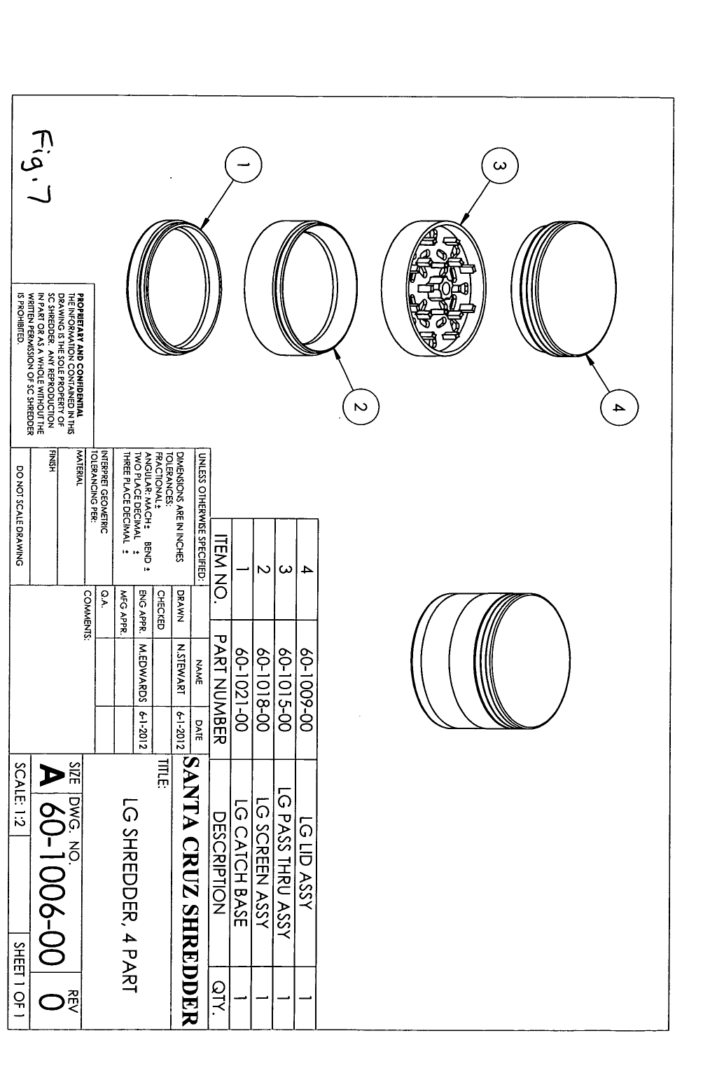

1. The Santa Cruz Shredder incorporates a custom radial angular cutting tooth design. With this design the cutting and grinding of herbs creates a very fine grind. This tooth design allows for bidirectional cutting and grinding. The multiple cutting teeth placement on the Santa Cruz Shredder grinders have been strategically positioned for maximum grind efficiency.
There is a 2 piece grinder design for just grinding and there is a 4 piece design for grinding that also has a mesh 100 screen that over a period of use will collect the finest grind (Keef). This 4 piece model consists of:
1: Top piece with custom teeth and a magnet.
2: An upper mid piece with a magnet, custom teeth and windows for the grind to fall through.
3: A lower mid piece is threaded on to the upper mid piece and has a screen pressed into it. It catches the course grind and the fine grind.
4: Keef falls through to the bottom piece which is a threaded catch basin.
There are 3 sizes produced.
1⅝ Small: The 1⅝ top includes 11 strategically positioned custom teeth with delrin ring, magnet and 8 tooth bottom with magnet.
2⅛ Medium: The 2⅛ top includes 15 strategically positioned custom teeth with delrin ring, magnet and 12 tooth bottom with magnet.
2¾ Large: The 2¾ top includes 20 strategically positioned custom teeth top with delrin ring, magnet and 16 tooth bottom with magnet.
